(19) United States
(12) Patent Application Publication
(10) Pub. No.: US 2024/0226645 A9
(43) Pub. Date: Jul. 11, 2024

(54) SYSTEM THAT ALLOWS UPPER EXTREMITY ACTIVE AND PASSIVE MOTION

(71) Applicant: Matthew ROGELL, Redding, CT (US)

(72) Inventor: Matthew ROGELL, Redding, CT (US)

(21) Appl. No.: 18/491,092

(22) Filed: Oct. 20, 2023

Related U.S. Application Data
(60) Provisional application No. 63/418,192, filed on Oct. 21, 2022.
(60) Provisional application No. 63/499,169, filed on Apr. 28, 2023.

(51) Int. Cl. A63B 21/00; A61H 1/02

(52) U.S. Cl. CPC A63B 21/4033; A61H 1/0274; A63B 21/4045; A63B 21/4049; A61H 2201/1215; A61H 2201/1635

(57) ABSTRACT

The system described herein comprises an articulated arm mechanically coupled to a wheel configured to allow a range of motion for a patient doing exercise for the upper extremities.

### CROSS REFERENCE TO RELATED APPLICATIONS

This patent application claims benefit of priority of U.S. Provisional Patent Application No. 63/418,192, filed 21 Oct. 2022, and U.S. Provisional Patent Application No. 63/499,169, filed 29 Apr. 2023, the entire contents of each of which are incorporated herein by reference.

### BACKGROUND

Upper extremity injuries are common. These injuries often occur due to repetitive movement and overuse of the upper extremity such as the shoulder. Injuries to areas such as the rotator cuff can also result from a fall or other injury to the shoulder. Damage to the rotator cuff can happen gradually over time, where the damage can be due to strains or tears in the rotator cuff, inflammation of the bursa (bursitis) in the shoulder or inflammation of the tendons (tendinitis) in the shoulder. These injuries may require upper extremity treatment, e.g., medical procedures such as rotator cuff repair surgery. Post surgery recovery usually includes exercise rehabilitation programs to help regain muscle strength, flexibility, and function of the upper extremity (e.g., shoulder, arms). There exists a need in the art for a system for the rehabilitation of the upper extremities.

### SUMMARY OF THE INVENTION

The system described herein is configured for movement of the upper extremities, independently or in concert, in two planes of movement, optionally with resistance. The system can be configured for movement of the upper extremities, independently or in concert, in a horizontal plane, e.g., forward and back, in a vertical plane, e.g., up and down, in the horizontal plane in a circular or elliptical motion, or a combination thereof. The system described herein is configured for movement of the upper extremities by a patient whether seated, standing, or dynamic, e.g., patient is in vertical movement (e.g., squats, holding squat position).

In an embodiment, a system for upper extremity exercises can comprise
a first handle mechanically coupled along an axis to a second handle;
a first arm portion comprising the handles, an internal track configured to allow movement of the handles long the track in the horizontal direction;
a second arm portion coupled to the first arm portion at an axis point,
   wherein the first arm portion and the second arm portion are coupled at an axis point to form an articulated arm;
a wheel mounted on a base comprising an internal track configured to allow vertical movement of the wheel along the track,
   wherein the wheel comprises a connection point located on the surface of the wheel between the center of the wheel and its perimeter;
   wherein the wheel is mechanically coupled to the distal end of the articulated arm; and
   wherein the wheel is configured for circular motion or elliptical motion.

In an embodiment, a system for upper extremity exercises can comprise
a first handle mechanically coupled along an axis to a second handle;
a first arm portion comprising the handles, an internal track configured to allow movement of the handles long the track in the horizontal direction;
a second arm portion coupled to the first arm portion at an axis point,
   wherein the first arm portion and the second arm portion are coupled at an axis point to form an articulated arm;
   wherein the axis point is positioned in a vertical track configured to allow vertical motion of the axis point of the articulated arm;
a wheel mounted on a base comprising an internal track configured to allow vertical movement of the wheel along the track,
   wherein the wheel comprises a connection point located on the surface of the wheel between the center of the wheel and its perimeter;
   wherein the wheel is mechanically coupled to the distal end of the articulated arm; and
   wherein the wheel is configured for circular motion or elliptical motion.

In an embodiment, a system for upper extremity exercises can comprise
a first handle mechanically coupled along an axis to a second handle;
a first arm portion comprising the handles, an internal track configured to allow movement of the handles long the track in the horizontal direction;
a second arm portion coupled to the first arm portion at an axis point,
   wherein the first arm portion and the second arm portion are coupled at an axis point to form an articulated arm;
   wherein the axis point is positioned in a vertical track configured to allow vertical motion of the axis point of the articulated arm;
a wheel mounted on a base comprising an internal track configured to allow vertical movement of the wheel along the track,
   wherein the wheel is mechanically coupled to the distal end of the articulated arm, optionally by means of a cable, on the perimeter of the wheel; and
   wherein the wheel is configured for circular motion or elliptical motion.

In an embodiment, a system for upper extremity rehabilitation of the upper body of a user comprising:
a first handle,
a second handle,
a first horizontal articulating arm with a front end and back end,
a second horizontal articulating arm with a front end and back end,
a first pivot post or button for allowing integration of vertical and horizontal motion into the system,
a second pivot post or button for allowing integration of vertical and horizontal motion into the system,
a vertical arm or stand with a top end and bottom end,
a first connecting rod with a first end and second end,
a second connecting rod with a first end and second end,
a motorized unit,
a first connecting element,
a second connecting element connecting the second end of the first connecting rod to the motorized unit,
a third connecting element connecting the first end of the second connecting rod,
a fourth connecting element connecting the second end of the second connecting rod to the motorized unit,
a motorized element housing unit, and
a vertical track within the motorized housing unit track with a top end and bottom end of the vertical track,
wherein
the first handle is directly stationarily attached near the front end of the first horizontal articulating arm, the first handle is attached to the outer surface of the elongated side of the first horizontal articulating arm,
the first horizontal articulating arm is attached to the first side of the vertical arm or stand with a first pivot post or button at the first horizontal articulating arm back end,
the back end of the first horizontal articulating arm is attached to the first connecting element which connects to the first end of the first connecting rod,
the second connecting element attaches the second end of the first connecting rod tangentially to the motorized unit,
the second handle is directly stationarily attached near the front end of the second horizontal articulating arm, the second handle is attached to the outer surface of the elongated side of the second horizontal articulating arm,
the second horizontal articulating arm is attached to the second side of the vertical arm or stand with the second pivot post or button at the second horizontal articulating arm back end,
the back end of the second horizontal articulating arm is attached to the third connecting element which connects to the first end of the second connecting rod,
the fourth connecting element attaches the second end of the second connecting rod tangentially to the motorized unit,
the motorized unit produces a circular motion with an adjustable radius to either increase or decrease horizontal or vertical motion expressed at the first or second pivot post or button and first and second handles,
the motorized unit rests upon the motorized housing unit, which has a vertical track to accommodate up and down movement of the motorized unit relative to radius adjustment,
the first and second pivot post or button are adjustable in height from the top end to the bottom end of the vertical arm or stand,
   wherein when motion in the X plane is performed, the subject pushes in a forward motion on the first and second handles and pulls in a reverse direction, or
   wherein when motion in the Y plane is performed, the subject pushes in a downward motion on the first and second handles then pulls in an upward motion, or
   wherein when motion in the X-Y plane is performed, the subject pushes in an upward and forward motion on the first and second handles, then pulls in a downward and reverse motion on the first and second handles.

In an embodiment, the vertical height of the first and second horizontal articulating arms is increased by lowering the motorized unit from the top end to the bottom end of the vertical track of the motorized housing unit.

In an embodiment, the vertical height of the first and second horizontal articulating arms is decreased by raising the motorized unit from the bottom end to the top end of the vertical track of the motorized housing unit.

In an embodiment, the first handle and second handle are L-shaped, optionally ergonomically designed. The first and second handle can be configured to work in concert, to move independently, and/or to rotate around a shared axis.

In an embodiment, the system can further comprise a computer system. The computer system can be configured to collect, process, transmit, or a combination thereof, physiological data. The physiological data comprises blood pressure, temperature, perspiration, respiration, or a combination thereof.

In an embodiment, the system further comprises a motor. The motor is mechanically coupled to wheel and configured for vertical motion of the wheel. The motor is mechanically coupled to arm, optionally articulated arm, and configured for vertical motion of the arm, optionally the articulated arm.

In an embodiment, a method for passively rehabilitating an upper extremity of a subject post-surgery, the method can comprise:
providing the system described herein,
programming the medical device system with a programmable operating unit attached to and that operates the motorized unit of the medical device system to limit, by inputting time or motion count, a rehabilitation exercise program, wherein the operating unit is wirelessly connected to an internet router,
pressing start to initiate the rehabilitation exercise program,
facing the first and second handles of the medical device system,
reaching the first and second handles with both hands,
grabbing the first and second handles with palms facing down,
moving from an upper position in a Y plane location of the first and second handles to a lower position in a Y plane location passively with the aid of the connected motorized unit which provides the force of motion from the upper position to the lower position,
returning motion from the lower position in a Y plane location of the first and second handles to the upper position in a Y plane location passively with the aid of the connected motorized unit which provides the force of motion from the lower position to the upper position,
repeating the motion from upper position to lower position, then lower position to upper position with the aid of the connected motorized unit which provides the force of motion from the lower position to the upper position,
stopping the rehabilitation exercise program where the programmed time or motion count has been achieved, and
sending rehabilitation exercise program data form the method to the physician for rehabilitation exercise evaluation.

In an embodiment, a method for passively rehabilitating an upper extremity of a subject post-surgery, the method can comprise:
providing the system described herein,
programming the medical device system with a programmable operating unit attached to and that operates the motorized unit of the medical device system to limit, by inputting time or motion count, a rehabilitation exercise program, wherein the operating unit is wirelessly connected to an internet router,
pressing start to initiate the rehabilitation exercise program,
facing the first and second handles of the medical device system,
reaching the first and second handles with both hands,
grabbing the first and second handles with palms facing down,
moving from a first position in a X plane location of the first and second handles to a second position in a X plane location passively with the aid of the connected motorized unit which provides the force of motion from the first position to the second position,
returning motion from the second position in a X plane location of the first and second handles to the first position in a X plane location passively with the aid of the connected motorized unit which provides the force of motion from the first position to the second position,
repeating the motion from first position to second position, then second position to first position with the aid of the connected motorized unit which provides the force of motion from the second position to the first position,
stopping the rehabilitation exercise program where the programmed time or motion count has been achieved, and
sending rehabilitation exercise program data form the method to the physician for rehabilitation exercise evaluation.

In an embodiment, a method for passively rehabilitating an upper extremity of a subject post-surgery, the method can comprise:
providing the system described herein,
programming the medical device system with a programmable operating unit attached to and that operates the motorized unit of the medical device system to limit, by inputting time or motion count, a rehabilitation exercise program, wherein the operating unit is wirelessly connected to an internet router,
pressing start to initiate the rehabilitation exercise program,
facing the first and second handles of the medical device system,
reaching the first and second handles with both hands,
grabbing the first and second handles with palms facing down,
moving from a first position of upward and forward motion in a X-Y plane location of the first and second handles to a downward and reverse motion
second position in a X-Y plane location passively with the aid of the connected motorized unit which provides the force of motion from the first position to the second position,
returning motion from the second position in a X-Y plane location of the first and second handles to the first position in a X-Y plane location passively with the aid of the connected motorized unit which provides the force of motion from the first position to the second position,
repeating the motion from first position to second position, then second position to first position with the aid of the connected motorized unit which provides the force of motion from the second position to the first position,
stopping the rehabilitation exercise program where the programmed time or motion count has been achieved, and
sending rehabilitation exercise program data form the method to the physician for rehabilitation exercise evaluation.

### BRIEF DESCRIPTION OF THE DRAWINGS

FIG. 1 (side view) depicts the system described herein. The system comprises a base with a vertical track coupled to a wheel or motorized unit configured to allow motion in the horizontal plane. The wheel or motorized unit is coupled to the distal end of an articulated arm and at the proximal end are handles. The articulated arm is configured to be locked in place, limiting motion to horizonal motion. The articulated arm is configured to be unlocked, allowing the distal end of the articulated arm and the proximal end of the articulated arm to move along the axis of the proximal end in a track. This permits the patient to move the arms in the horizontal plane, vertical plane, or a combination thereof. In the “unlocked” configuration, the articulated arm allows for the patient to move the upper extremity in a combination of horizontal and vertical planes in a shape, e.g., circular, elliptical motion. This configuration allows for an unexpected improvement in the total range of motion for the patient. The system can be equipped with a motor and computer system to allow for motor assisted movement, modulating the amount of resistance. A computer system can be integrated into the system to monitor use, collect and transmit data, and modulate the resistance, speed, direction, shape of movement, or a combination thereof, depending on the patient's needs.

FIG. 2 (side view) depicts the directional motion of the system. The articulated arm is directly mechanically coupled to a wheel or motorized unit and configured to move in the vertical plane (up and down). The system can be coupled to a motor and/or computer system to collect, process, and/or transmit data to adjust the resistance, speed, and/or duration of the exercise.

FIG. 3 (side view) depicts the directional motion of the system. The articulated arm is directly and/or mechanically coupled to a wheel or motorized unit and configured to move in the horizontal plane (forward and back) and in the vertical plane (up and down) or in combination as to move the handles in an elliptical motion. The system can be coupled to a motor and/or computer system to collect, process, and transmit data to adjust the resistance, speed, and/or duration of the exercise.

FIG. 4 depicts an embodiment of the system. The patient grasps handles at the proximal ends of two respective horizontal arms (401). The horizontal arms (401) can be locked in place, move vertically, move horizontally, or move both vertically and horizontally. The horizontal arms (401) are configured to move in the vertical direction or horizontal direction along respective tracks. The system can be placed in a housing (400) and electronically coupled to a motor, computer system, display (402), or a combination thereof. A motor within the housing (400) can be configured for mechanical assistance to modulate the amount of resistance or speed of the horizontal arms (401). The system can collect, process, transmit physiological data (e.g., blood pressure, temperature, perspiration, respiration), or a combination thereof. This data can be used to adjust resistance, speed, or time of the use.

FIG. 5 (side view) depicts a patient using the system. The patient grasps the handles at the proximal end of the horizontal arm (502). The horizontal arm (502) can be locked in place or rotate around the focal point (503). The horizontal arm is configured to move in the vertical direction along the track of the vertical component (504). The horizontal arm can be mechanically coupled to a wheel or motorized unit to allow for circular motion (or elliptical motion). The system can be electronically coupled to a motor, computer system, or both. The motor is configured for mechanical assistance to modulate the amount of resistance or speed. The computer system can collect, process, and/or transmit physiological data (e.g., blood pressure, temperature, perspiration, respiration). This data can be used to adjust resistance, speed, or time of the use.

FIG. 6 (side view) depicts a patient using an embodiment of the system described herein. Here, the patient is depicted grasping the arm by the handles and moving the arm in the vertical direction. The system can be coupled to a motor and/or computer system to collect, process, transmit data, or a combination thereof, to adjust the resistance, speed, duration of the exercise, or a combination thereof.

FIG. 7 (side view) depicts a patient using an embodiment of the system described herein. Here, the patient is depicted grasping the arm by the handles and moving the arm in the horizontal direction. The system can be coupled to a motor and/or computer system to collect, process, and/or transmit data to adjust the resistance, speed, duration of the exercise, or a combination thereof.

FIG. 8 (side view) depicts a patient using an embodiment of the system described herein. Here, the patient is depicted grasping separate arms (802) by handles (808). The arms (802) are stationary. The system can be coupled to a motor and/or computer system to collect, process, transmit, or a combination thereof, data to adjust the resistance, speed, duration of the exercise, or a combination thereof.

FIG. 9 (side view) depicts a patient using an embodiment of the system described herein. Here, the patient is depicted grasping the arm by the handle (908) and moving the arm (902) in an elliptical motion by a combination of horizontal, vertical, and circular motion from the wheel or motorized unit (905). The system can be coupled to a motor and/or computer system to collect, process, transmit, or a combination thereof, data to adjust the resistance, speed, duration of the exercise, or a combination thereof.

FIG. 10A (side view) depicts an embodiment of the system. The patient seated on chair (1403) grasps handles at the proximal ends of two respective horizontal arms (1001). The horizontal arms (1401) can be locked in place, and can be configured for horizontal, vertical, circular, or elliptical motion, or a combination thereof. The system can be placed in a housing (1000) and electronically coupled to a motor, computer system, display (1002), or a combination thereof. A motor within the housing (1000) can be configured for mechanical assistance to modulate the amount of resistance or speed of the horizontal arms (1001). FIGS. 10B (side view) and 10C (side view) each depict an embodiment of the system comprising a handle (1005) coupled to an articulated arm via axis points (1006) to a wheel or motorized unit (1004).

FIG. 11 (top view) depicts an embodiment of the system. The patient (1102) seated on chair grasps handles (1101) at the proximal ends of two respective arms (1001). The horizontal arms (1101) can be locked in place, and can be configured for horizontal, vertical, circular, or elliptical motion, or a combination thereof. The system can be placed in a housing (1100) and electronically coupled to a motor, computer system, display, or a combination thereof. A motor within the housing (1000) can be configured for mechanical assistance to modulate the amount of resistance or speed of the horizontal arms (1101).

### DETAILED DESCRIPTION OF THE EMBODIMENTS

In order that the invention herein described may be fully understood, the following detailed description is set forth. Various embodiments of the invention are described in detail and may be further illustrated by the provided examples. Additional viable variations of the embodiments can easily be envisioned.

### Definitions

Unless defined otherwise, all technical and scientific terms used herein have the same meaning as those commonly understood by one of ordinary skill in the art to which this invention belongs.

As used in the description herein and throughout the claims that follow, the meaning of “a,” “an,” and “the” includes plural reference unless the context clearly dictates otherwise.

“Patient,” as used herein, refers broadly to a human patient that may use the system described herein for upper extremity exercises, including rehabilitation (physical therapy).

### System for Upper Extremity Physical Therapy

The system described herein comprises handles (two facing opposite planes) coupled to an articulated arm configured to allow movement around a wheel or motorized unit. The system can be configured to allow only horizontal motion, only vertical motion, or a combination of horizontal and vertical motion as to move in a circular or elliptical direction. The system can be used in a seat position or a standing position, therefore fulfilling a need in upper extremity rehabilitation by being specific for the upper extremities for all patients (including those with lower extremity issues). Currently, programmable home exercise devices only target lower extremities and do not involve the upper extremity for their rehabilitation. Also, current devices are for lower extremity pedal applications or for only a circular motion for upper extremities. The system described herein allows for use of the upper extremities where each extremity can individually be exercised using different patterns of motion such as horizontal, vertical, circular, elliptical motions, or a combination thereof.

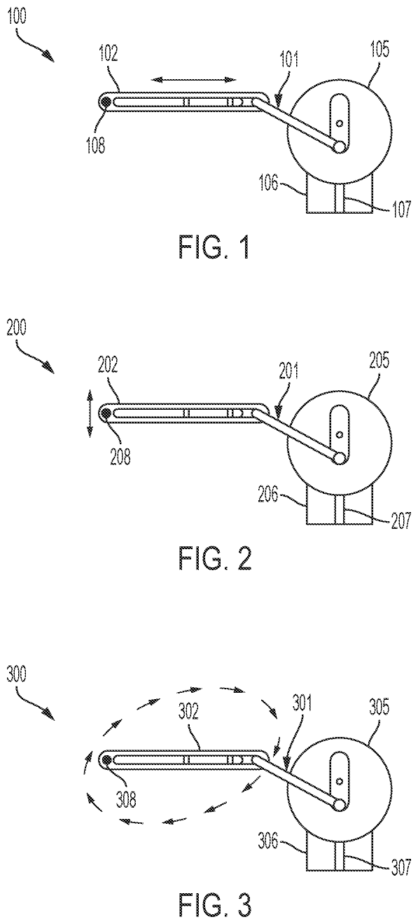

In reference to FIG. 1, in an embodiment, the system described herein (100), a side view of system described herein in motion in the horizontal X plane. As indicated, there is a horizontal articulating arm (102). To the left side of the horizontal articulating arm (102) there is a handle. In FIG. 1, a first handle (108) is shown. The device is contemplated with two handles, a first handle (108) and second handle (not visible in this plane) where such handles are large enough to be firmly grasped by the hands. In FIG. 1 the subject would grasp the handles (108) and move the handle connected to the horizontal articulating arm (102) in a rowing fashion in the X plane. The horizontal articulating arm (102) is pivotally connected to the connecting arm (101), where the connecting arm is pivotally connected to the motorized unit (105), where the motorized unit rest upon a motorized housing unit (106), which has a vertical track (107) to accommodate up and down movement of the motorized unit (105).

In an embodiment, the system (100) can comprise a base (106) with a vertical track (107) coupled to a wheel or motorized unit (105) configured to allow motion in the horizontal plane. The wheel or motorized unit is coupled to the distal end of an articulated arm (102) and at the proximal end are handles (108) (there can be two handles opposite each other). The articulated arm is configured to be locked in place, limiting motion to horizonal motion (101). The articulated arm is configured to be unlocked, allowing the distal end of the articulated arm (102) and the proximal end of the articulated arm to move along the axis of the proximal end in a track. This permits the patient to move the arms in the horizontal plane, vertical plane, or a combination thereof. In the “unlocked” configuration, the articulated arm allows for the patient to move the upper extremity in a combination of horizontal and vertical planes in a shape, e.g., circular, elliptical motion. This configuration allows for an unexpected improvement in the total range of motion for the patient. The system can be equipped with a motor and computer system to allow for motor assisted movement, modulating the amount of resistance. A computer system can be integrated into the system to monitor use, collect and transmit data, and modulate the resistance, speed, direction, shape of movement, or a combination thereof, depending on the patient's needs.

In reference to FIG. 2, the drawing depicts embodiment (200), a side view of directional motion of the device in the X, Y and X-Y planes. To the left of the horizontal articulating arm (202), there is a handle. The device is contemplated with two handles, a first handle and second handle where such handles are large enough to be firmly grasped by the hands. In FIG. 2 the subject would grasp the handle and move the handle connected to the horizontal articulating arm (202) in a rowing fashion or an up down motion in the x or y planes. The horizontal articulating arm (202) is pivotally connected to the connecting arm (201), where the connecting arm is pivotally connected to the wheel or motorized unit (205), where the wheel or motorized unit rests upon a housing unit (206), which has a vertical track (207) to accommodate up and down movement of the wheel or motorized unit (205).

In an embodiment, the system (200) is configured to allow the articulated arm (202) directly mechanically coupled to a wheel or motorized unit (205) and configured to move in the horizontal plane (forward and back) and in the vertical plane (up and down) or in combination as to move the handles in a circular motion, optionally in an elliptical motion. The proximal end of the articulated arm (202) can be mechanically locked to the distal end (201) and coupled to the wheel or motorized unit (205) inside the circumference. The wheel or motorized unit (205) can comprise a coupling on the surface of the wheel or motorized unit located between the outer circumference and the center. This wheel or motorized unit (205) can be configured to move in a vertical direction along a track (207) embedded in the base (206). The system can be coupled to a motor and/or computer system to collect, process, and/or transmit data to adjust the resistance, speed, and/or duration of the exercise. The computer system can also collect physiological data from the patient which can be processed to determine the appropriate resistance, speed, time, and direction of the exercise for the patient. The motor can be configured to allow for motor assisted movement.

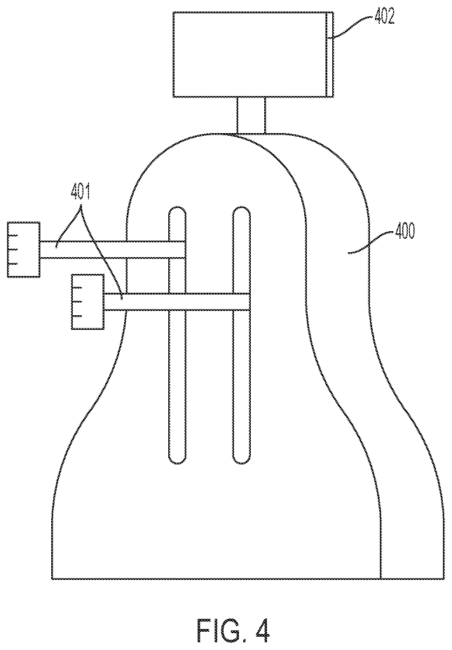

In reference to FIG. 3, the drawing depicts embodiment (300), the side view direction of possible direction motions of the embodiment in the X, Y and X-Y planes. The embodiment (300) is configured to allow the articulated arm (302) directly mechanically coupled to a wheel or motorized unit (305) and configured to move in the horizontal plane (forward and back) and in the vertical plane (up and down) or in combination as to move the handles in a circular motion, optionally in an elliptical motion. The system can be coupled to a motor and/or computer system to collect, process, and/or transmit data to adjust the resistance, speed, and/or duration of the exercise. The computer system can also collect physiological data from the patient which can be processed to determine the appropriate resistance, speed, time, and direction of the exercise for the patient. The motor can be configured to allow for motor assisted movement.

In reference to FIG. 4, a patient can grasp handles at the proximal ends of two respective horizontal arms (401). The horizontal arms (401) can be locked in place, move vertically, move horizontally, or both vertically and horizontally. The horizontal arms (401) are configured to move in the vertical direction or horizontal direction along respective tracks. The system can be placed in a housing (400) and electronically coupled to a motor, computer system, display (402), or a combination thereof. A motor within the housing (400) can be configured for mechanical assistance to modulate the amount of resistance or speed of the horizontal arms (401). The system can collect, process, and/or transmit physiological data (e.g., blood pressure, temperature, perspiration, respiration). This data can be used to adjust resistance, speed, or time of the use.

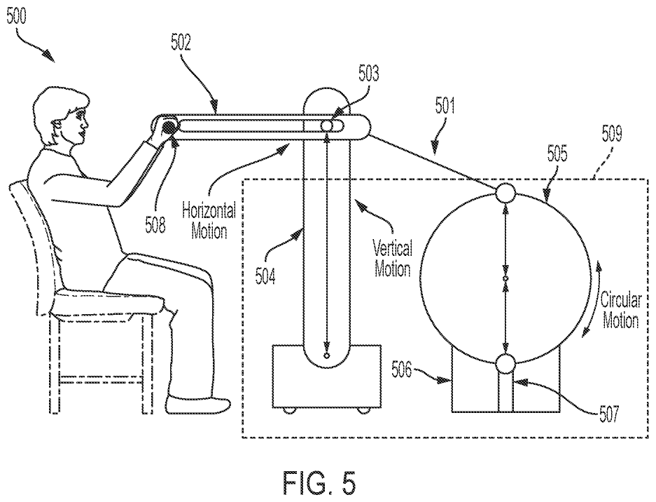

In reference to FIG. 5, the drawing depicts embodiment 500, a side view of the medical device system for upper extremity rehabilitation of the upper body of a user. The system comprises a first handle (508) a second handle (not shown), a first horizontal articulating arm (502), and a second horizontal articulating arm (not shown), a first pivot post or button (503), a second pivot post or button (not shown), a vertical arm or stand (504), a first connecting rod (501), a second connecting rod (not shown), a wheel or motorized unit (505), a motorized element housing unit (506), and a vertical track (507). Elements (504) to (507) can be included in a housing (509).

In an embodiment, FIG. 5 depicts a patient using the system (500). The patient grasps the handles (508) (a pair that can move together or independently) at the proximal end of the horizontal arm (502). The horizontal arm (502) can be locked in place or rotate around the focal point (503). The horizontal arm is configured to move in the vertical direction along the track of the vertical component (504). The horizontal arm can be mechanically coupled to a wheel (505) to allow for circular motion (or elliptical motion). The horizontal arm can be coupled to the wheel (505) at the outer edge of the wheel. The horizontal arm can be coupled to a vertical track that runs the diameter of the wheel (505). The wheel (505) can be mechanically coupled to a vertical track (507) integrated into a base (506). The wheel can be moved manually or moved by electronic means, e.g., motorized. The system can be electronically coupled to a motor, computer system, or both. The motor is configured for mechanical assistance to modulate the amount of resistance or speed. The patient can move the handles (508) in a horizontal direction along the track with the focal point (503). The patient can move the handles on the horizontal bar (502) in a vertical motion along the track (504). The patient can move the arm (502) in a combination of vertical and horizontal motion to allow for a circular motion. A computer system can be integrated into the system configured to collect, process, and/or transmit physiological data (e.g., blood pressure, temperature, perspiration, respiration). This data can be used to adjust resistance, speed, or time of the use. In any embodiment, the patient can use the system seated, standing, or in motion (e.g., doing squats).

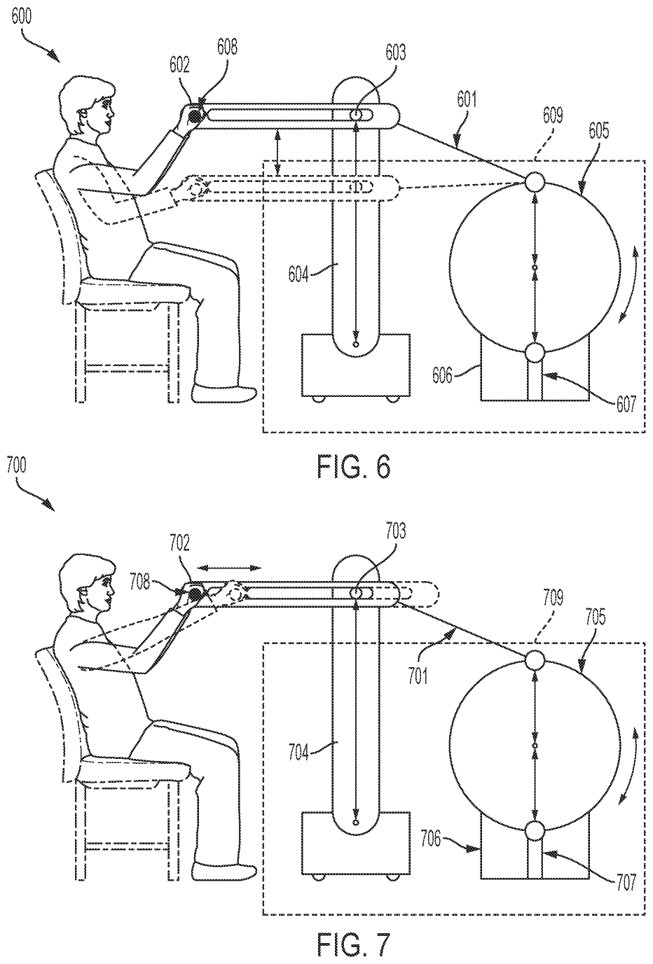

In reference to FIG. 6, the drawing depicts embodiment 600, a side view of the medical device system for upper extremity rehabilitation of the upper body of a user, where the user is using the device in the Y plane. The system comprises a first handle (608) a second handle (not shown), a first horizontal articulating arm (602), and a second horizontal articulating arm (not shown), a first pivot post or button (603), a second pivot post or button (not shown), a vertical arm or stand (604), a first connecting rod (601), a second connecting rod (not shown), a wheel or motorized unit (605), a motorized element housing unit (606), and a vertical track (607). Elements (604) to (607) can be included in a housing (609).

In an embodiment, FIG. 6 depicts a patient using the system (600). The patient grasps the handles (608) (a pair that can move together or independently) at the proximal end of the horizontal arm (602). The horizontal arm (602) can be locked in place or rotate around the focal point (603). Depicted in FIG. 6, the horizontal arm (602) is locked into place around the focal point (603), allowing the patient to move the horizontal arm in the vertical direction along the track of the vertical component (604). The horizontal arm can be mechanically coupled to a wheel or motorized unit (605) to allow for circular motion (or elliptical motion). The horizontal arm can be coupled to the wheel or motorized unit (605) at the outer edge of the wheel or motorized unit. The horizontal arm can be coupled to a vertical track that runs the diameter of the wheel (605). The wheel or motorized unit (605) can be mechanically coupled to a vertical track (607) integrated into a base (606). The wheel can be moved manually or moved by electronic means, e.g., motorized. Depicted in FIG. 6, the wheel or motorized unit moves to accommodate the horizontal movement. The system can be electronically coupled to a motor, computer system, or both. The motor is configured for mechanical assistance to modulate the amount of resistance or speed. A computer system can be integrated into the system configured to collect, process, and/or transmit physiological data (e.g., blood pressure, temperature, perspiration, respiration). This data can be used to adjust resistance, speed, or time of the use.

In reference to FIG. 7, the drawing depicts embodiment 700, a side view of the medical device system for upper extremity rehabilitation of the upper body of a user, where the user is using the device in the X plane. The system comprises a first handle (708) a second handle (not shown), a first horizontal articulating arm (702), and a second horizontal articulating arm (not shown), a first pivot post or button (703), a second pivot post or button (not shown), a vertical arm or stand (704), a first connecting rod (701), a second connecting rod (not shown), a wheel or motorized unit (705), a motorized element housing unit (706), and a vertical track (707). Elements (704) to (707) can be included in a housing (709).

In an embodiment, FIG. 7 depicts a patient using the system (700). The patient grasps the handles (708) (a pair that can move together or independently) at the proximal end of the horizontal arm (702). The horizontal arm (702) can be locked in place or rotate around the focal point (703). Depicted in FIG. 7, the horizontal arm (702) is locked into place around the focal point (703), allowing the patient to move the horizontal arm in the horizontal direction along the track of the horizontal arm (702). The horizontal arm can be mechanically coupled to a wheel or motorized unit (705) to allow for circular motion (or elliptical motion). The horizontal arm can be coupled to the wheel or motorized unit (705) at the outer edge of the wheel or motorized unit. The wheel or motorized unit (depicted in FIG. 7) is configured to allow horizontal movement. The horizontal arm can be coupled to a vertical track that runs the diameter of the wheel or motorized unit (705). The wheel or motorized unit (705) can be mechanically coupled to a vertical track (707) integrated into a base (706). The wheel can be moved manually or moved by electronic means, e.g., motorized. The system can be electronically coupled to a motor, computer system, or both. The motor is configured for mechanical assistance to modulate the amount of resistance or speed. A computer system can be integrated into the system configured to collect, process, and/or transmit physiological data (e.g., blood pressure, temperature, perspiration, respiration). This data can be used to adjust resistance, speed, or time of the use.

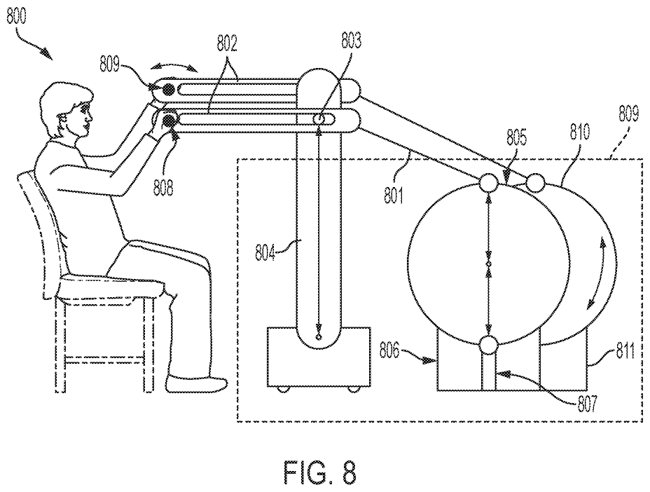

In reference to FIG. 8, the drawing depicts embodiment 800, a side view of the medical device system for upper extremity rehabilitation of the upper body of a user.

In an embodiment, FIG. 8 depicts a patient using the system (800). The patient grasps the handles (808) (a pair that can move together or independently) at the proximal end of horizontal arms (802). The horizontal arms (802) can be locked in place or rotate around focal points (803). Depicted in FIG. 8, the horizontal arms (802) are locked into place around focal points (803), allowing the patient to move rotate the handles (808) around a central axis at the proximal ends of horizonal arms (802). The horizontal arms can be mechanically coupled to a wheel or motorized unit (805) to allow for circular motion (or elliptical motion). The horizontal arms can be coupled to the wheel or motorized unit (805) at the outer edge of the wheel. The wheel or motorized unit (depicted in FIG. 8) is configured to allow horizontal movement. The horizontal arms can be coupled to a vertical track that runs the diameter of the wheel or motorized unit (805). The wheel or motorized unit (805) can be mechanically coupled to a vertical track (807) integrated into a base (806). Elements (804) to (807), (810), and (811) can be included in a housing (809). The wheel can be moved manually or moved by electronic means, e.g., motorized. The system can be electronically coupled to a motor, computer system, or both. The motor is configured for mechanical assistance to modulate the amount of resistance or speed. A computer system can be integrated into the system configured to collect, process, and/or transmit physiological data (e.g., blood pressure, temperature, perspiration, respiration). This data can be used to adjust resistance, speed, or time of the use.

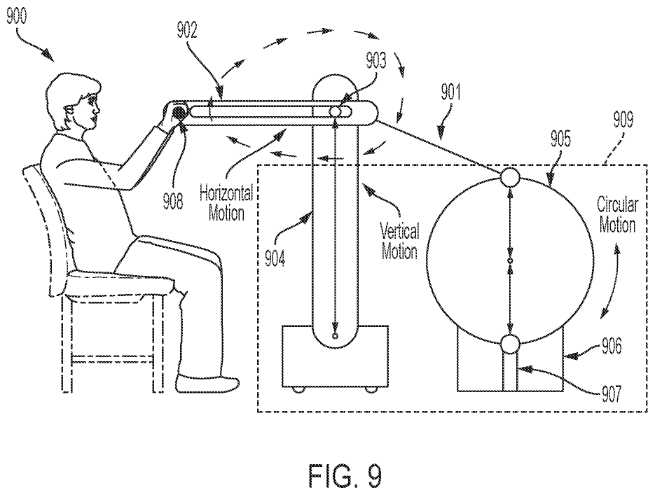

In reference to FIG. 9, the drawing depicts embodiment 900, side view of the medical device system for upper extremity rehabilitation of the upper body of a user, where the user is using the device in the X-Y planes. The system comprises a first handle (908) a second handle (not shown), a first horizontal articulating arm (902), and a second horizontal articulating arm (not shown), a first pivot post or button (903), a second pivot post or button (not shown), a vertical arm or stand (904), a first connecting rod (901), a second connecting rod (not shown), a motorized unit (905), a motorized element housing unit (906), and a vertical track (907). Elements (904) to (907) can be included in a housing (909).

In an embodiment, FIG. 9 depicts a patient using the system (900). The patient grasps the handles (909) (a pair that can move together or independently) at the proximal end of the horizontal arm (902). The horizontal arm (902) can be locked in place or rotate around the focal point (903). Depicted in FIG. 9, the horizontal arm (902) is not locked into place around the focal point (903), allowing the patient to move rotate the handles (909) around a central axis at the proximal end of the horizonal arm (902) and the axis point (903). The horizontal arm can be mechanically coupled to a wheel or motorized unit (905) to allow for elliptical motion. The horizontal arm can be coupled to the wheel or motorized unit (905) at the outer edge of the wheel. The wheel (depicted in FIG. 9) is configured to allow horizontal movement. The horizontal arm can be coupled to a vertical track that runs the diameter of the wheel or motorized unit (905). The wheel or motorized unit (905) can be mechanically coupled to a vertical track (907) integrated into a base (906). As shown in FIG. 9, the patient can exercise an improved range of motion from the rotation of the handles (908), the rotation around axis point (903), the horizontal motion of the arm (902) along the track, combined with vertical motion along the track (904), and the circular motion of the wheel or motorized unit (905). This combination of elements provides the patient with an expectantly improved range of motion to result in circular or elliptical motion(s). The wheel can be moved manually or moved by electronic means, e.g., motorized. The system can be electronically coupled to a motor, computer system, or both. The motor is configured for mechanical assistance to modulate the amount of resistance or speed. A computer system can be integrated into the system configured to collect, process, and/or transmit physiological data (e.g., blood pressure, temperature, perspiration, respiration). This data can be used to adjust resistance, speed, or time of the use.

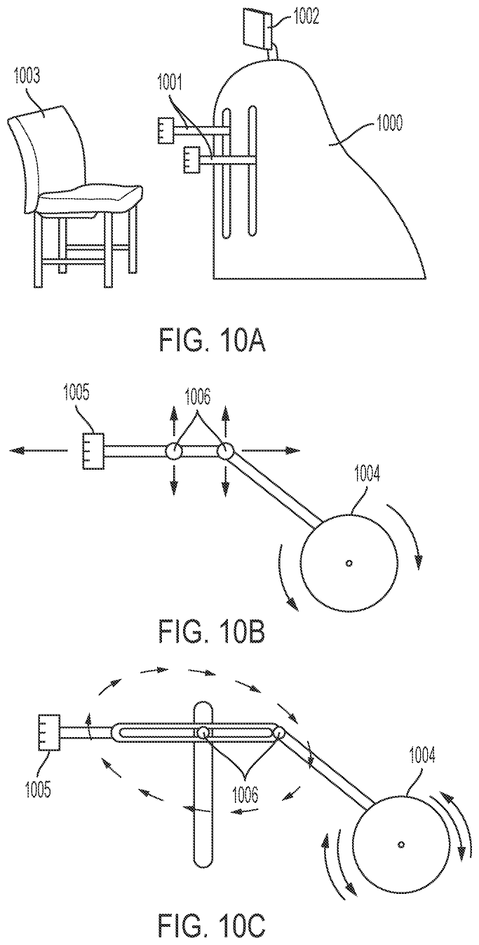

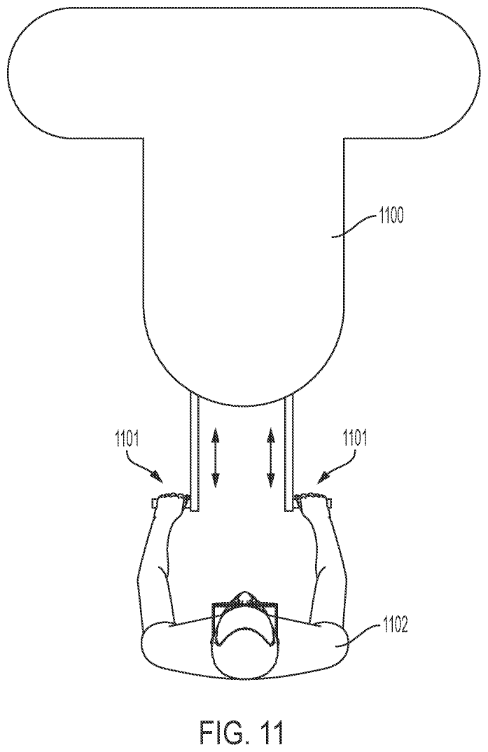

In references to FIGS. 10A, 10B, and 10C, a patient seated on chair (1003) can grasp handles at the proximal ends of two respective horizontal arms (1001). The horizontal arms (1001) can be locked in place, and can be configured for horizontal, vertical, circular, or elliptical motion, or a combination thereof. The system can be placed in a housing (1000) and electronically coupled to a motor, computer system, display (1002), or a combination thereof. A wheel or motor within the housing (1000) can be configured for mechanical assistance to modulate the amount of resistance or speed of the horizontal arms (1001). FIGS. 14B (side view) and 14C (side view) each depict an embodiment of the system comprising a handle (1005) coupled to an articulated arm via axis points (1006) to a wheel or motorized unit (1004). Shown in FIG. 14C is an embodiment configured for elliptical motion (e.g., achievable by the combination of horizontal and vertical motions).

The system comprises a first handle (e.g., 508, 608, 708, 808 and 908) a second handle (parallel to the first handle); a first horizontal articulating arm with a front end and back end (e.g., 502, 602, 702, 802 and 902), and a second horizontal articulating arm with a front end and back end (parallel to the second horizontal articulating arm). A first pivot post or button (e.g., 503, 603, 703, 803 and 903) is configured to provide for integration of vertical and horizontal motion into the system, a second pivot post or button configured for integration of vertical and horizontal motion into the system, a vertical arm or stand (e.g., 504, 604, 704, 804 and 904) with a top end and bottom end. A first connecting rod (e.g., 501, 601, 701, 801 and 901) with a first end and second end, a second connecting rod with a first end and second end, a wheel or motorized unit (e.g., 505, 605, 705, 805 and 905), a first connecting element, a second connecting element connecting the second end of the first connecting rod to the motorized unit, a third connecting element connecting the first end of the second connecting rod, a fourth connecting element connecting the second end of the second connecting rod to the motorized unit, a motorized element housing unit (e.g., 506, 606, 706, 806 and 906), and a vertical track (e.g., 507, 607, 707, 807 and 907) within the motorized housing unit track with a top end and bottom end of the vertical track, wherein the first handle (e.g., 508, 608, 708, 808 and 908) is directly stationarily attached near the front end of the first horizontal articulating arm (e.g., 502, 602, 702, 802 and 902), the first handle is attached to the outer surface of the elongated side of the first horizontal articulating arm, the first horizontal articulating arm is attached to the first side of the vertical arm or stand (e.g., 504, 604, 704, 804 and 904) with a first pivot post or button (e.g., 503, 603, 703, 803 and 903) at the first horizontal articulating arm back end, the back end of the first horizontal articulating arm is attached to the first connecting element which connects to the first end of the first connecting rod (e.g., 501, 601, 701, 801 and 901), the second connecting element attaches the second end of the first connecting rod tangentially to the motorized unit, the second handle is directly stationarily attached near the front end of the second horizontal articulating arm, the second handle is attached to the outer surface of the elongated side of the second horizontal articulating arm, the second horizontal articulating arm is attached to the second side of the vertical arm or stand with the second pivot post or button at the second horizontal articulating arm back end, the back end of the second horizontal articulating arm is attached to the third connecting element which connects to the first end of the second connecting rod, the fourth connecting element attaches the second end of the second connecting rod tangentially to the motorized unit, the wheel or motorized unit (e.g., 505, 605, 705, 805 and 905) produces a circular motion with an adjustable radius to either increase or decrease horizontal or vertical motion expressed at the first or second pivot post or button and first and second handles, the motorized unit rests upon the motorized housing unit (e.g., 506, 606, 706, 806 and 906), which has a vertical track (e.g., 507, 607, 707, 807 and 907) to accommodate up and down movement of the motorized unit relative to radius adjustment, the first and second pivot post or button are adjustable in height from the top end to the bottom end of the vertical arm or stand,
wherein when motion in the X plane is performed, the subject pushes in a forward motion on the first and second handles and pulls in a reverse direction, or
wherein when motion in the Y plane is performed, the subject pushes in a downward motion on the first and second handles then pulls in an upward motion, or
wherein when motion in the X-Y plane is performed, the subject pushes in an upward and forward motion on the first and second handles, then pulls in a downward and reverse motion on the first and second handles.
The medical device system also includes embodiments wherein the vertical height of the first and second horizontal articulating arms is increased by lowering the motorized unit from the top end to the bottom end of the vertical track of the motorized housing unit.

Additionally, the medical device system includes embodiments wherein the vertical height of the first and second horizontal articulating arms is decreased by raising the motorized unit from the bottom end to the top end of the vertical track of the motorized housing unit.

The system described herein can be used in methods for passively rehabilitating an upper extremity of a subject post-surgery, where the method comprises providing the medical device system described herein and programming the medical device system with a programmable operating unit attached to and that operates the motorized unit of the medical device system to limit, by inputting time or motion count, a rehabilitation exercise program wherein the operating unit is wirelessly connected to an internet router.

The method continues by pressing start to initiate the rehabilitation exercise program, facing the first and second handles of the medical device system, reaching the first and second handles with both hands, grabbing the first and second handles with palms facing down, moving from an upper position in a Y plane location of the first and second handles to a lower position in a Y plane location passively with the aid of the connected motorized unit which provides the force of motion from the upper position to the lower position.

The method further continues by returning motion from the lower position in a Y plane location of the first and second handles to the upper position in a Y plane location passively with the aid of the connected motorized unit which provides the force of motion from the lower position to the upper position, repeating the motion from upper position to lower position, then lower position to upper position with the aid of the connected motorized unit which provides the force of motion from the lower position to the upper position, stopping the rehabilitation exercise program where the programmed time or motion count has been achieved, and sending rehabilitation exercise program data form the method to the physician for rehabilitation exercise evaluation.

A method for passively rehabilitating an upper extremity of a subject post-surgery can comprise providing the medical device system described herein, programming the medical device system with a programmable operating unit attached to and that operates the motorized unit of the medical device system to limit, by inputting time or motion count, a rehabilitation exercise program, wherein the operating unit is wirelessly connected to an internet router.

This method continues by pressing start to initiate the rehabilitation exercise program, facing the first and second handles of the medical device system, reaching the first and second handles with both hands, grabbing the first and second handles with palms facing down, moving from an first position in a X plane location of the first and second handles to a second position in a X plane location passively with the aid of the connected motorized unit which provides the force of motion from the first position to the second position, returning motion from the second position in a X plane location of the first and second handles to the first position in a X plane location passively with the aid of the connected motorized unit which provides the force of motion from the first position to the second position, repeating the motion from first position to second position, then second position to first position with the aid of the connected motorized unit which provides the force of motion from the second position to the first position, stopping the rehabilitation exercise program where the programmed time or motion count has been achieved, and then sending rehabilitation exercise program data form the method to the physician for rehabilitation exercise evaluation.

A method for passively rehabilitating an upper extremity of a subject post-surgery can comprise providing the medical device system described herein, programming the medical device system with a programmable operating unit attached to and that operates the motorized unit of the medical device system to limit, by inputting time or motion count, a rehabilitation exercise program, wherein the operating unit is wirelessly connected to an internet router, pressing start to initiate the rehabilitation exercise program facing the first and second handles of the medical device system, reaching the first and second handles with both hands, grabbing the first and second handles with palms facing down, moving from a first position of upward and forward motion in a X-Y plane location of the first and second handles to a downward and reverse motion second position in a X-Y plane location passively with the aid of the connected motorized unit which provides the force of motion from the first position to the second position, returning motion from the second position in a X-Y plane location of the first and second handles to the first position in a X-Y plane location passively with the aid of the connected motorized unit which provides the force of motion from the first position to the second position.

The method continues by repeating the motion from first position to second position, then second position to first position with the aid of the connected motorized unit which provides the force of motion from the second position to the first position, stopping the rehabilitation exercise program where the programmed time or motion count has been achieved, and sending rehabilitation exercise program data form the method to the physician for rehabilitation exercise evaluation.

Computer System

The system described herein can collect, process, and/or transmit data, optionally in real time, as system is used by a patient. The data can be collected, processed, and/or transmitted by a computer system. The system described herein can be electronically coupled to the computer system by physical connections, wireless connections, or both. Optionally, the system described herein can be electronically coupled with a virtual computer system, for example operating remotely (e.g., “the cloud”). A computer system can be integrated into the system configured to collect, process, and/or transmit physiological data (e.g., blood pressure, temperature, perspiration, respiration). This data can be used to adjust resistance, speed, or time of the use.

A computer system can comprise a processor (Central Processing Unit, CPU) and supporting data storage. A computer system can comprise a programmable logic controller (PLC), microcontroller, distributed control system (DCS), or a combination thereof. Further, the data analysis can be implemented across multiple devices and/or other components local or remote to one another. The data analysis can be implemented in a centralized system, or as a distributed system for additional scalability. Moreover, any reference to software can include non-transitory computer readable media that when executed on a computer, causes the computer to perform a series of steps, such as the methods according to exemplary aspects.

The computer systems described herein can include data storage such as network accessible storage, local storage, remote storage, or a combination thereof. Data storage can utilize a redundant array of inexpensive disks (“RAID”), tape, disk, a storage area network (“SAN”), an internet small computer systems interface (“iSCSI”) SAN, a Fiber Channel SAN, a common Internet File System (“CIFS”), network attached storage (“NAS”), a network file system (“NFS”), or other computer accessible storage. The data storage can be a database, such as an Oracle database, Amazon Web Services (AWS), a Microsoft SQL Server database, a DB2 database, a MySQL database, a Sybase database, an object-oriented database, a hierarchical database, or other database. Data storage can utilize flat file structures for storage of data. The database can be a remote database, e.g., cloud database.

For example, the computer system can include various components and/or different computer systems, including components that are physically separated or remote from one another. A first computer can be used to access a remotely located server on which the method according to exemplary aspects is executed. The first computer can access the server through an interface, such as a web-based interface. The output of the method can be provided through the web-based interface. The method can be carried out over a computer-based network, such as the Internet. The data collected by the system described herein can be stored, processed, and/or accessed on a local database, remote database (“cloud-based database”), or a combination thereof. Further, the computer system can access additional databases for condition settings, resistance, heart rate, blood pressure, rehabilitation algorithms, or combinations thereof.

The systems described herein can include one or more network-enabled computers connected to the system described herein. As referred to herein, a network-enabled computer can include, but is not limited to: e.g., any computer device, or communications device including, e.g., a server, a network appliance, a personal computer (PC), workstation, a mobile device, a smartphone, a handheld PC, a personal digital assistant (PDA), a router, a thin client, a fat client, an Internet browser, or other device.

The network-enabled computers can execute one or more software applications to, for example, receive data as input from an entity accessing the network-enabled computer system, process received data, transmit data over a network, and receive data over a network. The one or more network-enabled computers can also include one or more software applications to configured to determine parameters of the rehabilitation (exercise) program.

The analysis and execution of the rehabilitation program described herein can be fully automated.

The description below describes servers, devices, and network elements that can include one or more modules, some of which are explicitly shown, others are not. As used herein, the term “module” can be understood to refer to computing software, firmware, hardware, or various combinations thereof. It is noted that the modules are exemplary. The modules can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

It is further noted that the software described herein can be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, network elements, processors) separately. The functions described as being performed at various components can be performed at other components, and the various components can be combined and/or separated. Other modifications also can be made.

The network that electronically couples system described herein, motor, and computer system can be a wireless network, a wired network or any combination of wireless network and wired network. For example, the network can include one or more of a fiber optics network, a passive optical network, a cable network, a telephony network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.1 1η and 802.1 1g or any other wired or wireless network for transmitting and/or receiving a data signal. In addition, the network can include, without limitation, telephone line, fiber optics, IEEE Ethernet 802.3, a wide area network (“WAN”), a local area network (“LAN”), or a global network such as the Internet. Also, the network can support an Internet network, a wireless communication network, a cellular network, or the like, or any combination thereof. The network can further include one, or any number of the exemplary types of networks mentioned above operating as a standalone network or in cooperation with each other. The network can utilize one or more protocols of one or more network elements to which it is communicatively coupled. The network can translate to or from other protocols to one or more protocols of network devices. Although the network can be depicted or described herein as one network, it should be appreciated that according to one or more aspects, the network can comprise a plurality of interconnected networks, such as, for example, a service provider network, the Internet, a broadcaster's network, a cable television network, corporate networks, and home networks.

In an aspect, the network that electronically couples the system described herein, the motor, and computer system configured to collect data and execute the rehabilitation program can be a wireless network, a wired network or any combination of wireless network and wired network. For example, the network can include one or more of a fiber optics network, a passive optical network, a cable network, a telephony network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.1 1η and 802.1 1g or any other wired or wireless network for transmitting and/or receiving a data signal. In addition, the network can include, without limitation, telephone line, fiber optics, IEEE Ethernet 802.3, a wide area network (“WAN”), a local area network (“LAN”), or a global network such as the Internet. Also, the network can support an Internet network, a wireless communication network, a cellular network, or the like, or any combination thereof. The network can further include one, or any number of the exemplary types of networks mentioned above operating as a standalone network or in cooperation with each other. The network can utilize one or more protocols of one or more network elements to which it is communicatively coupled. The network can translate to or from other protocols to one or more protocols of network devices. Although the network can be depicted or described herein as one network, it should be appreciated that according to one or more aspects, the network can comprise a plurality of interconnected networks, such as, for example, a service provider network, the Internet, a broadcaster's network, a cable television network, corporate networks, home networks, or a combination thereof.

All publications (e.g., Non-Patent Literature), patents, patent application publications, and patent applications mentioned in this specification are indicative of the level of skill of those skilled in the art to which this invention pertains. All such publications (e.g., Non-Patent Literature), patents, patent application publications, and patent applications are herein incorporated by reference to the same extent as if each individual publication, patent, patent application publication, or patent application was specifically and individually indicated to be incorporated by reference.

While the foregoing invention has been described in connection with these embodiments, it is not to be limited thereby but is to be limited solely by the scope of the claims which follow.

1. A system for upper extremity exercises comprising
a first handle mechanically coupled along an axis to a second handle;
a first arm portion comprising the handles, an internal track configured to allow movement of the handles long the track in the horizontal direction;
a second arm portion coupled to the first arm portion at an axis point,
wherein the first arm portion and the second arm portion are coupled at an axis point to form an articulated arm;
a wheel mounted on a base comprising an internal track configured to allow vertical movement of the wheel along the track,
wherein the wheel comprises a connection point located on the surface of the wheel between the center of the wheel and its perimeter;
wherein the wheel is mechanically coupled to the distal end of the articulated arm; and
wherein the wheel is configured for circular motion or elliptical motion.

2. The system of claim 1, wherein the second arm portion coupled to the first arm portion at an axis point positioned in a vertical track configured to allow vertical motion of the axis point of the articulated arm.

3. The system of claim 1, wherein the wheel is mechanically coupled to the distal end of the articulated arm, by means of a cable, on the perimeter of the wheel.

4. The system of claim 1, further comprising
a first horizontal articulating arm with a front end and back end,
a second horizontal articulating arm with a front end and back end,
a first pivot post or button for allowing integration of vertical and horizontal motion into the system,
a second pivot post or button for allowing integration of vertical and horizontal motion into the system,
a vertical arm or stand with a top end and bottom end,
a first connecting rod with a first end and second end,
a second connecting rod with a first end and second end,
a motorized unit,
a first connecting element,
a second connecting element connecting the second end of the first connecting rod to the motorized unit,
a third connecting element connecting the first end of the second connecting rod,
a fourth connecting element connecting the second end of the second connecting rod to the motorized unit,
a motorized element housing unit, and
a vertical track within the motorized housing unit track with a top end and bottom end of the vertical track,
wherein
the first handle is directly stationarily attached near the front end of the first horizontal articulating arm, the first handle is attached to the outer surface of the elongated side of the first horizontal articulating arm,
the first horizontal articulating arm is attached to the first side of the vertical arm or stand with a first pivot post or button at the first horizontal articulating arm back end,
the back end of the first horizontal articulating arm is attached to the first connecting element which connects to the first end of the first connecting rod,
the second connecting element attaches the second end of the first connecting rod tangentially to the motorized unit,
the second handle is directly stationarily attached near the front end of the second horizontal articulating arm, the second handle is attached to the outer surface of the elongated side of the second horizontal articulating arm,
the second horizontal articulating arm is attached to the second side of the vertical arm or stand with the second pivot post or button at the second horizontal articulating arm back end,
the back end of the second horizontal articulating arm is attached to the third connecting element which connects to the first end of the second connecting rod,
the fourth connecting element attaches the second end of the second connecting rod tangentially to the motorized unit,
the motorized unit produces a circular motion with an adjustable radius to either increase or decrease horizontal or vertical motion expressed at the first or second pivot post or button and first and second handles,
the motorized unit rests upon the motorized housing unit, which has a vertical track to accommodate up and down movement of the motorized unit relative to radius adjustment,
the first and second pivot post or button are adjustable in height from the top end to the bottom end of the vertical arm or stand,
wherein when motion in the X plane is performed, the subject pushes in a forward motion on the first and second handles and pulls in a reverse direction, or
wherein when motion in the Y plane is performed, the subject pushes in a downward motion on the first and second handles then pulls in an upward motion, or
wherein when motion in the X-Y plane is performed, the subject pushes in an upward and forward motion on the first and second handles, then pulls in a downward and reverse motion on the first and second handles.

5. The system of claim 4, wherein the vertical height of the first and second horizontal articulating arms is increased by lowering the motorized unit from the top end to the bottom end of the vertical track of the motorized housing unit.

6. The system of claim 4, wherein the vertical height of the first and second horizontal articulating arms is decreased by raising the motorized unit from the bottom end to the top end of the vertical track of the motorized housing unit.

7. The system of claim 1, wherein the first handle and second handle are L-shaped, optionally ergonomically designed.

8. The system of claim 1, wherein the system further comprises a computer system.

9. The system of claim 8, wherein the computer system is configured to collect, process, and/or transmit physiological data.

10. The system of claim 9, wherein the physiological data comprises blood pressure, temperature, perspiration, respiration, or a combination thereof.

11. The system of claim 1, wherein the system further comprises a motor.

12. The system of claim 1, wherein the system further comprises a display.

13. The system of claim 12, wherein the motor is mechanically coupled to wheel and configured for vertical motion of the wheel.

14. The system of claim 12, wherein the motor is mechanically coupled to the arm, optionally the articulated arm, and configured for vertical motion of the arm, optionally the articulated arm.

15. A method for passively rehabilitating an upper extremity of a subject post-surgery, the method comprises:
providing the system of claim 1,
programming the medical device system with a programmable operating unit attached to and that operates the motorized unit of the medical device system to limit, by inputting time or motion count, a rehabilitation exercise program, wherein the operating unit is wirelessly connected to an internet router,
pressing start to initiate the rehabilitation exercise program,
facing the first and second handles of the medical device system,
reaching the first and second handles with both hands,
grabbing the first and second handles with palms facing down,
moving from a first position of upward and forward motion in a X-Y plane location of the first and second handles to a downward and reverse motion
second position in a X-Y plane location passively with the aid of the connected motorized unit which provides the force of motion from the first position to the second position,
returning motion from the second position in a X-Y plane location of the first and second handles to the first position in a X-Y plane location passively with the aid of the connected motorized unit which provides the force of motion from the first position to the second position,
repeating the motion from first position to second position, then second position to first position with the aid of the connected motorized unit which provides the force of motion from the second position to the first position,
stopping the rehabilitation exercise program where the programmed time or motion count has been achieved, and
sending rehabilitation exercise program data form the method to the physician for rehabilitation exercise evaluation.
